(19) United States
(12) Patent Application Publication
(10) Pub. No.: US 2022/0082913 A1
(43) Pub. Date: Mar. 17, 2022

(54) LENS MODULE AND PROJECTION DEVICE

(71) Applicant: IVIEW DISPLAYS (SHENZHEN) COMPANY LTD., Shenzhen (CN)

(72) Inventors: Liang Mei, Shenzhen (CN); Steve Yeung, Shenzhen (CN); Zhiqiang Gao, Shenzhen (CN); Mingnei Ding, Shenzhen (CN)

(21) Appl. No.: 17/535,794

(22) Filed: Nov. 26, 2021

Related U.S. Application Data
(63) Continuation of application No. PCT/CN2020/142213, filed on Dec. 31, 2020.

(30) Foreign Application Priority Data
Dec. 31, 2019 (CN) 201911420504.8

(51) Int. Cl. G03B 21/14; G02B 7/04

(52) U.S. Cl. CPC G03B 21/142; G02B 7/04

(57) ABSTRACT

A lens module and a projection device are provided. The lens module includes a sleeve, a lens barrel and a locking ring, wherein an end of the sleeve is provided with a deformable conical protrusion; an end of the lens barrel is received in the sleeve through the end of the sleeve; and the locking ring is nested on an outer side of the end of the sleeve, and an inner surface of the locking ring is provided with a conical structure mating with the conical protrusion.

### CROSS-REFERENCE TO RELATED APPLICATIONS

This application is a continuation-application of International (PCT) Patent Application No. PCT/CN2020/142213, filed on Dec. 31, 2020, which claims priority to Chinese Patent Application No. 201911420504.8, filed with the National Intellectual Property Administration of China on Dec. 31, 2019, and entitled “LENS MODULE AND PROJECTION DEVICE”, the entire contents of which are incorporated herein by reference.

### TECHNICAL FIELD

Embodiments of the present disclosure relate to the technical field of optics, and in particular, relate to a lens module and a projection device.

### BACKGROUND

Recently, most projection devices are configured with a manual focusing module and an automatic focusing function. The automatic focusing function is capable of quickly achieving focusing in a case where the projection device switches an application scenario, but with a substantially consistent projection distance, or micro movement is caused to the projection device due to mis-touch on the projection device. In a case where the application scenario is switched, and the projection distance is significantly changed, for example, increase of one or two meters, the manual focusing is generally employed to achieve quick focusing.

During practice of embodiments of the present disclosure, the present inventors have found that the related art at least has the following problem. In the conventional projection device or optical engine with the manual focusing function, when a user manually adjusts the position of a lens barrel, the lens barrel is generally fixed by screwing up a screw between the lens barrel and a mating member thereof (general a sleeve) to increase friction therebetween. If the screw is not tightened, or threads of the screw are aged, the position of the lens barrel may not be maintained unchanged, and thus reliability is poor.

### SUMMARY

An embodiment of the present disclosure provide a lens module. The lens module includes: a sleeve, an end of the sleeve being provided with a deformable conical protrusion; a lens barrel, an end of the lens barrel being received in the sleeve through the end of the sleeve; and a locking ring, nested on an outer side of the end of the sleeve, and an inner surface of the locking ring being provided with a conical structure mating with the conical protrusion.

Another embodiment of the present disclosure provide a projection device. The projection device includes a lens module. The lens module includes: a sleeve, an end of the sleeve being provided with a deformable conical protrusion; a lens barrel, an end of the lens barrel being received in the sleeve through the end of the sleeve; and a locking ring, nested on an outer side of the end of the sleeve, and an inner surface of the locking ring being provided with a conical structure mating with the conical protrusion.

### BRIEF DESCRIPTION OF THE DRAWINGS

One or more embodiments are illustrated by way of example, and not by limitation, in the figures of the accompanying drawings, wherein modules and steps having the same reference numeral designations represent like modules and steps throughout. The drawings are not to scale, unless otherwise disclosed.

FIG. 1 is a schematic view of an overall structure of a lens module according to an embodiment of the present disclosure.

FIG. 2 is a cutaway view of the lens module in FIG. 1 according to the embodiment of the present disclosure.

FIG. 3 is an exploded view of the lens module according to the embodiment of the present disclosure.

FIG. 4 is a cutaway view of the lens module in FIG. 3 according to the embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical”, “horizontal”, “left”, “right”, and similar expressions are for illustration purposes. For ease of definition of the connection structure, the positions of the components are defined using relative positions of a sleeve against a lens barrel and a locking ring as a reference.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

In an optical engine with manual focusing such as a projection device and a video recording device, in the case that a position of a lens barrel is adjusted and focusing adjustment is completed, how to keep the lens barrel in the adjusted position is challenging. Conventional practice is to generate friction between the lens barrel and a mating member (generally a sleeve) thereof by screwing up a screw to prevent the position of the lens barrel from changing upon completion of focusing of the lens barrel. Alternatively, focusing movement of the lens barrel is achieved by adding a structural member. Of the two methods, in the first method, debris is easily generated due to rotation friction in the process of tightly pushing against the lens barrel by the screw, thereby greatly impairing focusing smoothness of the system and reliability of the optical engine; and in the second method, a magnitude of an outer diameter of the optical engine is increased due to the adding of the structural member, and thus the competitiveness of the optical engine is restricted.

In view of this, the present disclosure provides a lens module which has compact structure, low cost, good reliability, and fastened lens. In the lens module, the pressure is generated between the lens barrel and the sleeve due to deformation among structural members (the sleeve, the lens barrel, and the locking ring) such that the position of the lens barrel is maintained at a preset position, thereby fastening the lens barrel. In addition, a conical protrusion designed to adapt to the deformation is arranged on the sleeve, and a conical structure is arranged on the locking ring. The conical protrusion and the conical structure are mated with, and locked to each other to press the conical protrusion on the sleeve, such that the conical protrusion is subjected to deformation, and thus generates the friction with the lens barrel, thereby preventing the lens barrel from being loosened. Furthermore, a male threaded structure and a female threaded structure may be respectively arranged on the sleeve and the locking ring for further locking, such that a stress between the sleeve and the lens barrel is increased.

Specifically, the embodiments of the present disclosure are further described with reference to the accompanying drawings hereinafter.

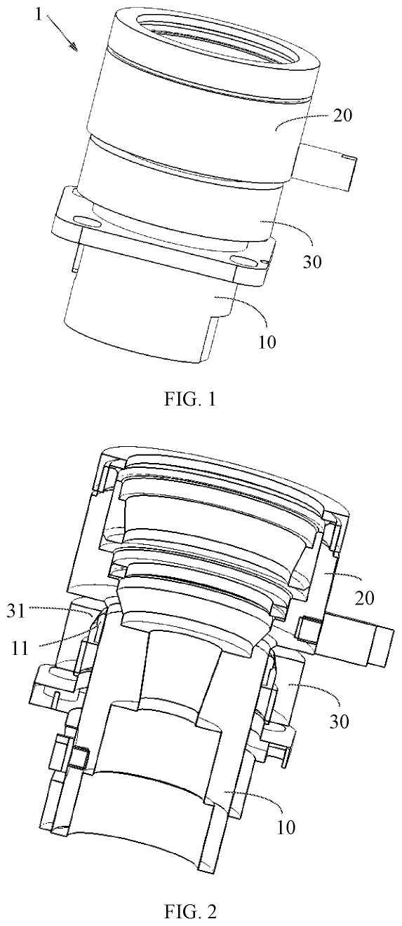

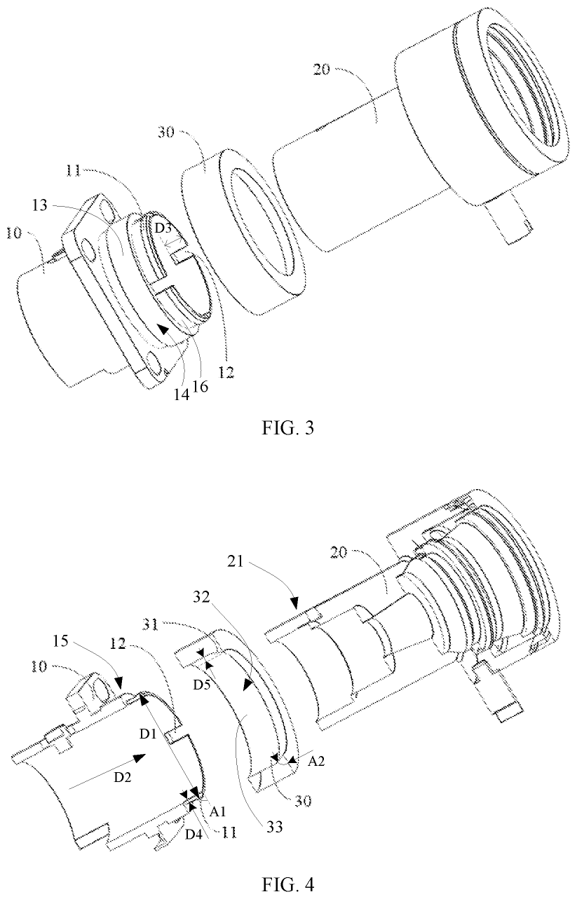

An embodiment of the present disclosure provides a lens module. Referring to FIG. 1 and FIG. 2, a schematic view of an overall structure and a cutaway view of a lens module 1 according to an embodiment of the present disclosure are illustrated. The lens module 1 includes a sleeve 10, a lens barrel 20, and a locking ring 30. An end 15 (see FIG. 4) of the sleeve 10 is provided with a deformable conical protrusion 11. An end 21 (see FIG. 3) of the lens barrel 20 is received in the sleeve 10 through the end 15 of the sleeve 10. The locking ring 30 is nested on an outer side of the end 15 of the sleeve 10, and an inner surface 32 (see FIG. 4) of the locking ring 30 is provided with a conical structure 31 mating with the conical protrusion 11. The lens module 1 according to the embodiment of the present disclosure is capable of fastening the lens barrel 20 in the sleeve 10, and thus achieving good reliability.

In some embodiments, the sleeve 10, the lens barrel 20, and locking ring 30 may be made of metal or glass, and preferably, a hard material. The hard material exerts a supporting force and is easy to shape. Specifically, the material may be selected and arranged according to actual needs, which is not limited to the description in the embodiments of the present disclosure.

An inner wall of the sleeve 10 is smooth, such that the lens barrel 20 may be smoothly inserted into the sleeve 10. Where necessary, the inner wall of the lens barrel 20 may be applied with a lubricant to allow the lens barrel 20 to be smoothly inserted into the sleeve 10.

The lens barrel 20 may be a lens barrel in varieties of projection devices, video recording devices, and optical engines. For example, the lens barrel 20 may be a refractive lens barrel, a reflective lens barrel, or a catadioptric lens barrel. The refraction lens barrel is constituted by a focusing assembly, a lens barrel group, an objective lens group, and a light shield, and is configured to reduce chromatic aberration. The reflective lens barrel is mainly constituted by a primary reflective lens group, a lens barrel group, a focusing assembly, and a secondary reflective lens group. The catadioptric lens barrel is mainly constituted by a primary reflective lens group, a barrel lens group, a focusing assembly, a correcting lens, and a secondary reflective lens group.

The lens barrel 20 may be configured to accommodate an optical lens (not illustrated) to receive an optical object and achieve optical imaging. The optical lens may be a short-focus lens, a middle-focus lens, or a long-focus lens in terms of a focal length; the optical lens may be a wide-angle lens, a standard lens, or a telephoto lens in terms of a magnitude of a field of view; the optical lens may be a fixed-aperture fixed-focus lens, a manual-aperture fixed-focus lens, an automatic-aperture fixed-focus lens, an automatic-aperture motorized zoom lens, a motorized zoom lens, or the like in terms of structure. The optical lens may be made of a material that is partially or completely reflective or penetrative. Typically, the material includes glass or plastic. During taking an image by the optical lens, a side, proximal to an object to be shot, on a light path is an enlargement side, and a side, proximal to a photosensitive element, on the light path is a reduction side.

This embodiment of the present disclosure provides a lens module. The lens module includes a sleeve, a lens barrel and a locking ring, wherein an outer surface of an end of the sleeve is provided with a deformable conical protrusion; an end of the lens barrel is received in the sleeve through the end of the sleeve; and the locking ring is nested flush with an outer side of the end of the sleeve, and an inner surface of the locking ring is provided with a conical structure mating with the conical protrusion. The lens module according to the embodiments of the present disclosure is capable of fastening the lens barrel in the sleeve, and thus achieving good reliability.

Referring to both FIG. 3 and FIG. 4, an exploded view and a cutaway view of the lens module according to the embodiment of the present disclosure are illustrated.

In this embodiment of the present disclosure, an outer surface 14 of the end of the sleeve 10 is further provided with a male threaded structure 13; and the inner surface 32 of the locking ring 30 is further provided with a female threaded structure 33 mating with the male threaded structure 13. In this embodiment of the present disclosure, the conical protrusion 11 and the conical structure 31 that are mated with each other are arranged at the same time, and the male threaded structure mates with the female threaded structure, such that a friction force between the lens barrel 20 and the sleeve 10 is enhanced, and the lens barrel 20 may be better locked in the sleeve 10.

In this embodiment of the present disclosure, the end 15 of the sleeve 10 is further provided with a groove 12 capable of causing the sleeve 10 to deform. At least four grooves 12 are provided, wherein the at least four grooves 12 are uniformly distributed on the end of the sleeve 10. The grooves 12 uniformly distributed on the end of the sleeve 10 may ensure that the sleeve 10 is circumferentially uniform when being pressed and deformed, such that eccentricity of the lens barrel 20 caused by extrusion is prevented, and a central axis of the sleeve 10 is coincident with a central axis of the lens barrel 20.

A periphery of the sleeve 10 is extended outside by a predetermined length in a diameter direction, and is compressed to an outer surface of the sleeve to define the conical protrusion 11. An outer diameter D1 of the conical protrusion 11 gradually reduces in a direction D2 toward the end 15 of the sleeve 10. The conical protrusion 11 has a cone angle A1 of 45 degrees. The conical protrusion 11 has a height of 5.1 mm, i.e., the groove 12 has an axial length D3 of 5.1 mm. A neck part 16 connected with the conical protrusion 11 has a minimum thickness D4 of 0.1 mm. The conical structure 31 has a cone angle A2 of 60 degrees. The conical structure 31 has a height D5 of 1 mm.

In the case that the lens module 1 according to the embodiments of the present disclosure is installed, first, the lens barrel 20 is inserted into the sleeve 10, and the sleeve 10 is locked by the locking ring 30, such that the sleeve 10 is engaged with the locking ring 30 by the conical protrusion 11 and the conical structure 31, and the sleeve 10 is pressed towards a center to fix the lens barrel 20 by the conical protrusion 11 having the cone angle of 60 degrees, and the conical structure having the cone angle of 45 degrees on the locking ring. Further, the sleeve 10 and the locking ring 30 are further fixed together by the female threaded structure and the male threaded structure, such that the pressure of the sleeve 10 for pressing towards the center is increased, and thus lens barrel 20 is further fixed.

Another embodiment of the present disclosure provides a projection device. The projection device includes the lens module described in the above embodiment. The lens module 1 according to the embodiment of the present disclosure may be further applicable to a projection device (not illustrated). The projection device configured with the lens module 1 is capable of stabilizing the lens barrel 20 at a preset position, and achieving good reliability.

It should be noted that the lens module 1 according to this embodiment of the present disclosure and the lens module 1 according to the above embodiment may be the same lens module. The specific structure and the implementation of the lens module are as described in the above embodiment of the present disclosure, which is not detailed herein.

The above embodiment of the present disclosure provides a lens module. The lens module includes a sleeve, a lens barrel and a locking ring, wherein an outer surface of the end of the sleeve is provided with a deformable conical protrusion; an end of the lens barrel is received in the sleeve through the end of the sleeve; and the locking ring is nested on an outer side of the end of the sleeve, and an inner surface of the locking ring is provided with a conical structure mating with the conical protrusion. The lens module according to the embodiments of the present disclosure is capable of fastening the lens barrel in the sleeve, and thus achieving good reliability.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A lens module, comprising:
a sleeve, an end of the sleeve being provided with a deformable conical protrusion;
a lens barrel, an end of the lens barrel being received in the sleeve through the end of the sleeve; and
a locking ring, nested on an outer side of the end of the sleeve, and an inner surface of the locking ring being provided with a conical structure mating with the conical protrusion.

2. The lens module according to claim 1, wherein
an outer surface of the end of the sleeve is further provided with a male threaded structure; and
the inner surface of the locking ring is further provided with a female threaded structure mating with the male threaded structure.

3. The lens module according to claim 2, wherein the end of the sleeve is further provided with a groove capable of causing the sleeve to deform.

4. The lens module according to claim 3, wherein at least four grooves are provided, the at least four grooves being uniformly distributed on the end of the sleeve.

5. The lens module according to claim 1, wherein an outer diameter of the conical protrusion gradually reduces in a direction toward the end of the sleeve.

6. The lens module according to claim 1, wherein the conical protrusion has a cone angle of 45 degrees.

7. The lens module according to claim 3, wherein the groove has an axial length of 5.1 mm, and a neck part connected with the conical protrusion has a minimum thickness of 0.1 mm.

8. The lens module according to claim 1, wherein the conical structure has a cone angle of 60 degrees.

9. The lens module according to claim 1, wherein the conical structure has a height of 1 mm.

10. A projection device, comprising a lens module; wherein the lens module comprises:
a sleeve, an outer surface of an end of the sleeve being provided with a deformable conical protrusion;
a lens barrel, an end of the lens barrel being received in the sleeve through the end of the sleeve; and
a locking ring, nested on an outer side of the end of the sleeve, and an inner surface of the locking ring being provided with a conical structure mating with the conical protrusion.

11. The projection device according to claim 10, wherein
an outer surface of the end of the sleeve is further provided with a male threaded structure; and
the inner surface of the locking ring is further provided with a female threaded structure mating with the male threaded structure.

12. The projection device according to claim 11, wherein the end of the sleeve is further provided with a groove capable of causing the sleeve to deform.

13. The projection device according to claim 12, wherein at least four grooves are provided, the at least four grooves being uniformly distributed on the end of the sleeve.

14. The projection device according to claim 10, wherein an outer diameter of the conical protrusion gradually reduces in a direction toward the end of the sleeve.

15. The projection device according to claim 10, wherein the conical protrusion has a cone angle of 45 degrees.

16. The projection device according to claim 12, wherein the groove has an axial length of 5.1 mm, and a neck part connected with the conical protrusion has a minimum thickness of 0.1 mm.

17. The projection device according to claim 10, wherein the conical structure has a cone angle of 60 degrees.

18. The projection device according to claim 10, wherein the conical structure has a height of 1 mm.
